(19) United States
(12) Patent Application Publication
(10) Pub. No.: US 2016/0301178 A1
(43) Pub. Date: Oct. 13, 2016

(54) WIRE DISCHARGE DEVICE

(71) Applicant: SUMITOMO WIRING SYSTEMS, LTD., Yokkaichi-shi, Mie (JP)

(72) Inventor: Makoto HATTORI, Mie (JP)

(73) Assignee: Sumitomo Wiring Systems, Ltd., Yokkaichi-shi, Mie (JP)

(21) Appl. No.: 15/100,485

(22) PCT Filed: Dec. 3, 2014
(86) PCT No.: PCT/JP2014/081978

§ 371 Date: May 31, 2016

(30) Foreign Application Priority Data
Dec. 18, 2013 (JP) 2013-261221

(51) Int. Cl. H01R 43/28; H01R 43/052

(52) U.S. Cl. CPC H01R 43/28; H01R 43/052

(57) ABSTRACT

A wire discharge device includes: two bar support portions each capable of supporting a wire holding bar in which a plurality of wire holding portions are arranged in parallel; a wire end portion holding and setting portion for sequentially setting wires onto the plurality of wire holding portions of the wire holding bars supported by the bar support portions; and a moving mechanism portion for moving the two bar support portions back and forth between a wire receiving position at which a wire is received from the wire end portion holding and setting portion and a take-out position at which the wire holding bar is taken out, wherein the take-out positions of the two bar support portions are different with the wire receiving position therebetween in a direction perpendicular to the direction in which the wire holding bars extend.

### TECHNICAL FIELD

This invention relates to techniques for holding and conveying both end portions of a wire that has been cut to a predetermined length.

### BACKGROUND ART

A wire harness in a vehicle is manufactured by bundling wires with terminals. A wire with terminals is manufactured by drawing out an elongated wire from a ring-shaped wire bundle and cutting it into a predetermined length, and further performing a process of stripping off covering portions of end portions thereof, a terminal crimping process, and the like on the cut wire.

As a device for manufacturing such wires with terminals, for example, a cut-and-crimp setting device described in Patent Document 1 and the like exist.

### CITATION LIST

### Patent Documents

Patent Document 1: JP 2009-152104A

### SUMMARY OF INVENTION

### Technical Problem

Incidentally, in the cut-and-crimp setting device described in Patent Document 1, each set of wires with terminals manufactured by a cut-and-crimp mechanism portion is held at an elongated wire holding bar, which is also called a setting bar, by a wire holding bar support portion, a wire end portion holding and setting portion, and the like, and is moved to a take-out position together with the wire holding bar.

However, in the wire holding bar support portion of the cut-and-crimp setting device described in Patent Document 1, there is a concern that, when two bar support mechanism portions for supporting respective wire holding bars pass by each other in order to replace the wire holding bar on which the wires with terminals are set with an empty wire holding bar, the wire with terminals gets entangled or caught.

An object of the present invention is to provide a technique with which a wire does not easily get entangled or caught when replacing a wire holding bar.

### Solution to Problem

In order to solve the foregoing problem, a wire discharge device according a first aspect includes: two bar support portions each capable of supporting a wire holding bar in which a plurality of wire holding portions are arranged in parallel; a wire end portion holding and setting portion for sequentially setting wires onto the plurality of wire holding portions of the wire holding bars supported by the bar support portions; and a moving mechanism portion for moving the two bar support portions back and forth between a wire receiving position at which a wire is received from the wire end portion holding and setting portion and a take-out position at which the wire holding bar is taken out, wherein the take-out positions of the two bar support portions are different with the wire receiving position therebetween in a direction perpendicular to the direction in which the wire holding bars extend.

A wire discharge device according to a second aspect is the wire discharge device according to the first aspect, wherein the moving mechanism portion unitarily moves the two bar support portions with the same driving source such that the two bar support portions can move back and forth while having a fixed interval therebetween.

A wire discharge device according to a third aspect is the wire discharge device according to the first or second aspect, wherein an entangling prevention sheet portion is provided in a part located below the wire holding bars supported by the bar support portions.

A wire discharge device according to a fourth aspect is the wire discharge device according to any one of the first to third aspects, wherein the bar support portions each support one side end portion of the wire holding bar in the extending direction, and the wire discharge device further comprises a guiding portion capable of restricting a height of another side end portion of the wire holding bar supported by each of the bar support portions in the extending direction when the bar support portion moves, such that the wire holding bar supported by the bar support portion is horizontal in a state of being located at the wire receiving position.

A wire discharge device according to a fifth aspect is the wire discharge device according to the fourth aspect, further including: a bar end portion support mechanism portion capable of pressing down the other side end portion of the wire holding bar in the extending direction toward the one side end portion in a state where the wire holding bar supported by each of the bar support portion is located at the wire receiving position.

### Advantageous Effects of Invention

With the wire discharge devices according to the first to fifth aspects, the take-out positions of the wire holding bars supported by the respective bar support portions are different with the wire receiving position therebetween in a direction perpendicular to the extending directions of the wire holding bars. Accordingly, the wire holding bars do not easily pass by each other when moving back and forth between the wire receiving position and the respective take-out positions, and it is thereby possible to suppress the wire getting entangled or caught.

In particular, with the wire discharge device according to the second aspect, the moving mechanism portion moves the two bar support portions with the same driving source. Therefore, the two bar support portions can move back and forth in a state of constantly having a fixed interval therebetween. As a result, the two bar support portions never pass by each other, and it is possible to suppress the wire getting entangled or caught.

In particular, with the wire discharge device according to the third aspect, the entangling prevention sheet portion is provided in a part located below the wire holding bar in each bar support portion. It is accordingly possible to suppress the wires held by the wire holding bars getting entangled or caught below the wire holding bars.

With the wire discharge device according to the fourth aspect, each bar support portion supports the one side end portion of the wire holding bar in the extending direction, and the guiding portion capable of restricting the height of the other side end portion of the wire holding bar supported by the bar support portion in the extending direction when the bar support portion moves is further provided. Therefore, the wire holding bar supported by each bar support portion is restricted so as to be horizontal in a state of being located at the wire receiving position. It is thereby possible to suppress an operation of setting a wire being started in a state where the wire holding bar has not been set at a correct position. Furthermore, since the wire holding bar is supported at one end, the wire holding bar can be easily removed, and it is possible at the time of removal thereof to suppress the wire getting entangled or caught.

The wire discharge device according to the fifth aspect further includes the bar end portion support mechanism portion capable of pressing down the other side end portion of the wire holding bar in the extending direction toward the one side end portion in a state where the wire holding bar supported by each bar support portion is located at the wire receiving position. It is accordingly possible to suppress the operation of setting the wire being started in a state where the wire holding bar has not been set at the correct position.

### BRIEF DESCRIPTION OF DRAWINGS

FIG. 1 is an illustrative diagram showing an overall configuration of a cut-and-crimp setting device.

FIG. 2 is an illustrative diagram showing a wire discharge device according to an embodiment.

FIG. 3 is a plan view showing a wire holding bar.

FIG. 4 is a front view showing the wire holding bar.

FIG. 5 is a front view showing a wire end portion conveying and setting portion.

FIG. 6 is a front view showing a part of the wire end portion conveying and setting portion.

FIG. 7 is a side view showing a part of the wire end portion conveying and setting portion.

FIG. 8 is a schematic plan view showing a wire holding bar supply mechanism portion.

FIG. 9 is a schematic plan view showing the wire holding bar supply mechanism portion.

FIG. 10 is a schematic side view showing the wire holding bar supply mechanism portion.

FIG. 11 is a schematic side view showing the wire holding bar supply mechanism portion.

FIG. 12 is a side view showing a part of the wire holding bar supply mechanism portion.

FIG. 13 is a plan view showing a part of the wire holding bar supply mechanism portion.

FIG. 14 is a front view showing a part of the wire holding bar supply mechanism portion.

### DESCRIPTION OF EMBODIMENTS

Hereinafter, a wire discharge device according to an embodiment will be described. Here, a wire discharge device 30 according to the embodiment is incorporated on the downstream side in a cut-and-crimp setting device 1.

### 1. Cut-and-Crimp Setting Device

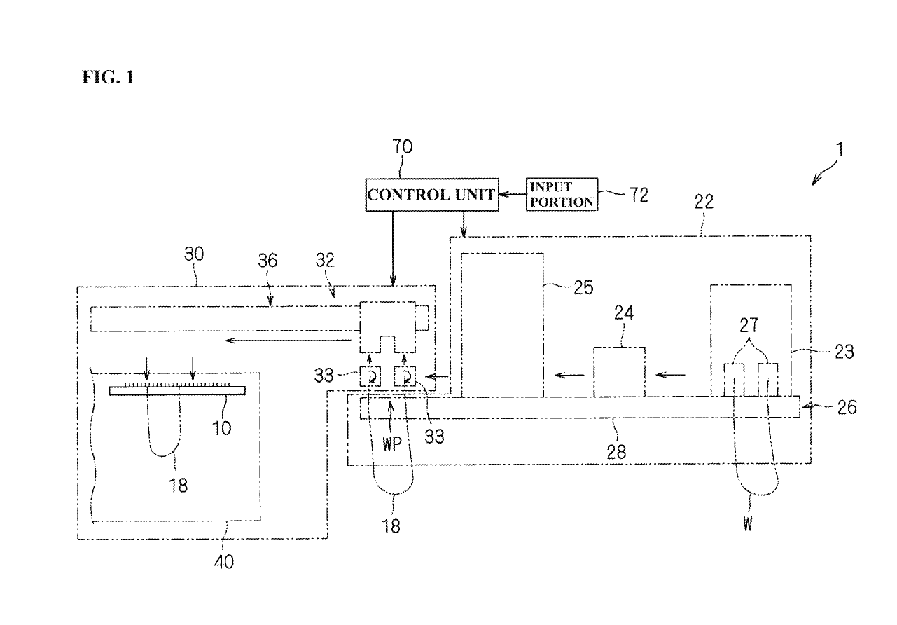

First, an overall configuration of the cut-and-crimp setting device 1 will be described. FIG. 1 is an illustrative diagram showing the overall configuration of the cut-and-crimp setting device 1. This cut-and-crimp setting device 1 is for processing, using the wire discharge device 30, a wire 18 with terminals that has been processed by a cut-and-crimp mechanism portion 22. The cut-and-crimp setting device 1 is configured such that the long length of the wire is cut off and terminals are crimped thereto by the aforementioned cut-and-crimp mechanism portion 22, and, in the wire discharge device 30, end portions of this wire 18 with terminals are sequentially set onto the a wire holding bar 10, so that the wire 18 with terminals can be taken to the outside together with the wire holding bar 10.

The cut-and-crimp mechanism portion 22 is configured to be able to cut off a wire and crimp terminals to end portions of the wire. Here, the cut-and-crimp mechanism portion 22 is configured to be able to manufacture multiple types of wires 18 with terminals in a predetermined order, and the wires 18 with terminals can be manufactured in the order in which multiple types of wires 18 with terminals are mixed as appropriate, or the same type of wires 18 with terminals can also be continuously manufactured.

More specifically, the cut-and-crimp mechanism portion 22 includes a wire length adjusting and cutting portion 23, a wire stripping portion 24, and a terminal crimping portion 25, and also has a wire end portion conveying mechanism portion 26 for conveying wire end portions.

The wire length adjusting and cutting portion 23 is configured to be able to selectively cut multiple types of wires to a predetermined length, and can employ, for example, a configuration having a reel, around which a wire is wound and housed, a wire length measuring and drawing portion for drawing the wire from the reel while measuring the wire length, a wire cutting portion for cutting off the drawn wire, and a folding-back portion for folding back the drawn wire in a U-shape. The wire is drawn from the reel by the predetermined length by the driving of the wire length measuring and drawing portion, and the wire is cut off with the wire cutting portion. An end portion of the drawn wire is folded back by the folding-back portion into a substantial U-shape, and both end portions thereof are set onto the aforementioned wire end portion conveying mechanism portion 26. A wire W that has been cut out into the predetermined length is thereby obtained. Moreover, a wire selecting and supplying portion in which a plurality of aforementioned reels are provided and that enables a wire to be selectively supplied from each reel is provided. This portion enables multiple types of wires to be switched as appropriate and cut into the predetermined length.

As a configuration of the wire length adjusting and cutting portion 23 for thus selectively supplying multiple types of wires and cutting the wires into the predetermined length, for example, a well-known configuration disclosed in JP 9-306257A or the like can be employed.

The wire stripping portion 24 is for stripping end portions of the wire W, and may employ a configuration having a pair of stripping blades that can be brought close to and separated from each other, and a back-and-forth driving portion for pointing the stripping blades to the end portions of the wire W and driving the stripping blades back and forth, for example. Covering portions of the end portions of the wire W are stripped off by moving the pair of stripping blades so as to bring the stripping blades close to the end portions of the wire that has been conveyed to this wire stripping portion 24, and moving the pair of stripping blades toward the end portions of the wire in a state where the stripping blades are caused to cut into the covering portions of the wire W. As such a wire stripping portion 24, various well-known configurations can be employed, such as a configuration in which a covering portion is removed with a pair of stripping blades as mentioned above.

The terminal crimping portion 25 is configured to be able to selectively crimp multiple types of terminals to end portions of the wire W, and for example, a crimping device can be used that has multiple pairs of die sets and in which one of the multiple pairs of die sets can be set at a common terminal crimping position, the crimping terminal being configured to be able to selectively supply the multiple types of terminals to the aforementioned terminal crimping position.

Upon the end portions of the wire W that have been stripped off by the aforementioned wire stripping portion 24 being conveyed to this terminal crimping portion 25, predetermined terminals, which are set in advance, are selected and supplied, and a pair of die sets that corresponds to the predetermined terminals is selected and set at the terminal crimping position. Thus, the predetermined terminals are crimped to the end portions of the wire W, and the wire 18 with terminals is obtained.

As such a terminal crimping portion 25, for example, a well-known configuration disclosed in JP 2005-135822A may be employed.

The wire end portion conveying mechanism portion 26 is configured to be able to hold the end portions of the wire W and convey them from the wire length adjusting and cutting portion 23 to a delivery position WP on the wire discharge device 30 side via the wire stripping portion 24 and the terminal crimping portion 25. More specifically, the wire end portion conveying mechanism portion 26 has a pair of wire end portion holding portions 27 capable of holding and releasing both end portions of the wire W, and a wire end portion back-and-forth driving portion 28 for moving this wire end portion holding portions 27 back and forth between the delivery position WP and each of the positions corresponding to the wire length adjusting and cutting portion 23, the wire stripping portion 24, and the terminal crimping portion 25.

The wire end portion holding portions 27 each have a pair of holding pieces that can open and close. An end portion of the pair of holding pieces is supported so as to be able to rotate around a predetermined axis, and the posture of the pair of holding pieces can be changed between a close posture of being closed in an erected manner and an open posture of being open in a lodged manner by being driven by an actuator such as an air cylinder, or the like. This pair of wire end portion holding portions 27 is movably provided in a state in which it is separate from the wire end portion back-and-forth driving portion 28 at a predetermined interval.

The wire end portion back-and-forth driving portion 28 has an actuator such as a linear motor, and is configured to move the aforementioned pair of wire end portion holding portions 27 toward the delivery position WP from the wire length adjusting and cutting portion 23 via the wire stripping portion 24 and the terminal crimping portion 25. The wire end portion back-and-forth driving portion 28 temporarily stops when the end portions of the wire W held by the wire end portion holding portions 27 pass through operation positions in the wire stripping portion 24 and the terminal crimping portion 25, and causes a stripping process, a terminal crimping process, and the like to be performed on the end portions of the wire W. Then, the end portions of the wire 18 with terminals that has been cut into the predetermined length, whose end portions have been stripped, and to which the terminals have been crimped, are conveyed to the delivery position WP that is set at a position closer to the wire discharge device 30 than to the aforementioned terminal crimping portion 25, and here, these end portions are configured to be delivered to the wire discharge device 30.

Note that, although the cut-and-crimp mechanism portion 22 in this embodiment is configured such that both the type of wires and the type of terminals can be changed, it is also possible that only either one of them can be changed. The cut-and-crimp mechanism portion 22 may also be configured to continuously crimp one type of terminals to the end portions of one type of wires.

### 2. Wire Discharge Device

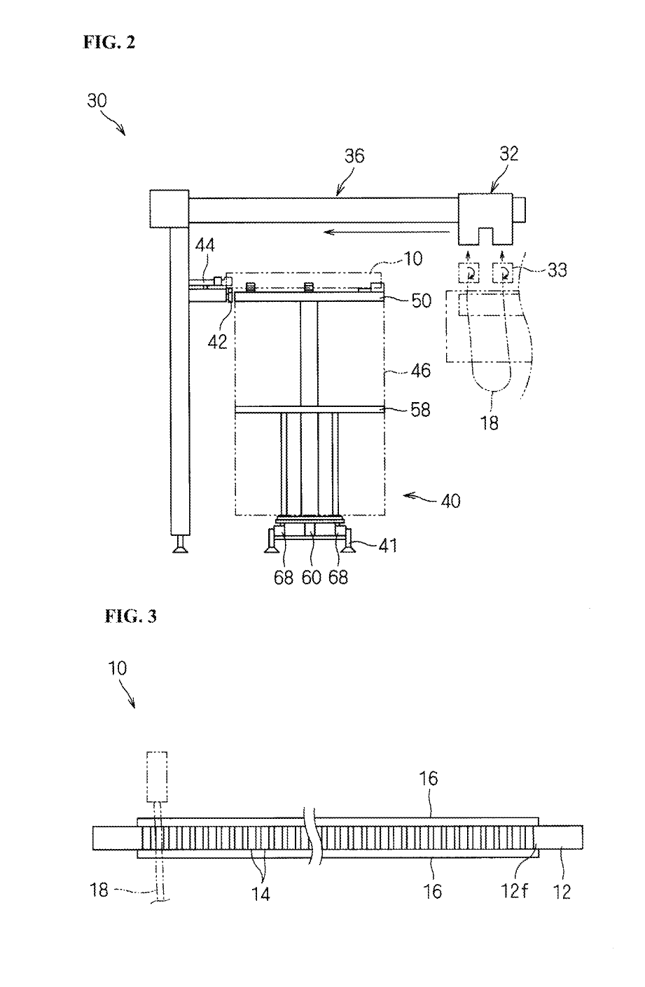

Next, the wire discharge device 30 will be described. FIG. 2 is an illustrative diagram showing the wire discharge device 30 according to the embodiment.

The wire discharge device 30 includes a wire end portion holding and setting portion 32 and a bar supply mechanism portion 40. The bar supply mechanism portion 40 includes two bar support portions 50 and a moving mechanism portion 60.

The wire end portion holding and setting portion 32 is configured to be able to hold the end portions of the wire 18 with terminals to which the terminals have been crimped by the cut-and-crimp mechanism portion 22, and sequentially set the end portions of the wire 18 with terminals onto respective wire holding portions 14 of the wire holding bar 10 supported by the bar support portion 50. The bar supply mechanism portion 40 is configured to move, with the moving mechanism portion 60, the two bar support portions 50 back and forth between a wire receiving position RP at which the wire is received from the wire end portion holding and setting portion and take-out positions TP at which the respective wire holding bars 10 are taken out.

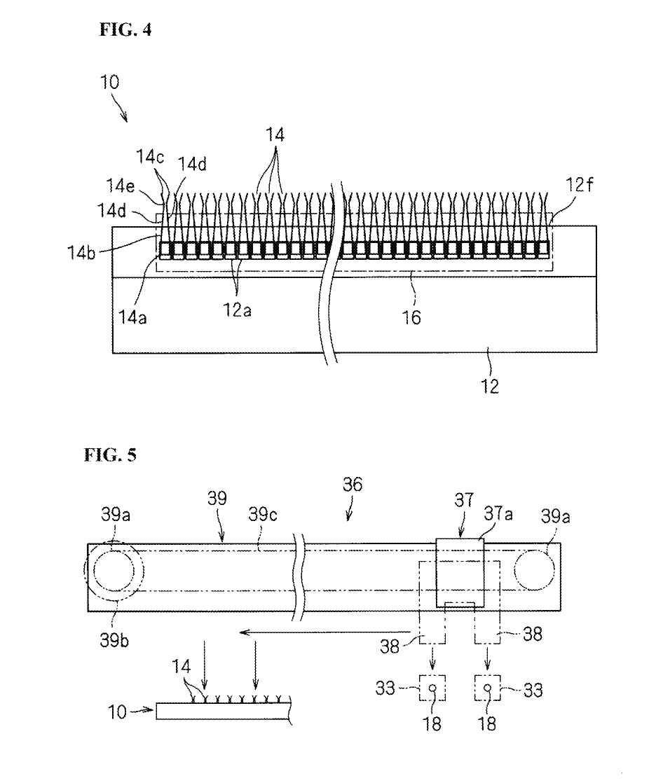

Here, the wire holding bar 10 onto which the end portions of the wire 18 with terminals are set will be described. FIG. 3 is a plan view showing the wire holding bar 10, and FIG. 4 is a front view showing this wire holding bar 10.

The wire holding bar 10 has a main portion 12, a plurality of wire holding portions 14, and a side plate portion 16.

The main portion 12 is formed in an elongated bar shape, and a plurality of holding recess portions 12a are formed at intervals in the longitudinal direction of the main portion 12 in a part on the side of one side surface 12f extending in the longitudinal direction thereof. The holding recess portions 12a are each formed in a groove shape that opens to the one side surface 12f of the main portion 12 and both side surfaces adjacent to the one side surface, and an opening end portion of each holding recess portion 12a on the one side surface 12f side is narrower than on the base end side.

Each wire holding portion 14 is a member configured to be able to hold an end portion of the wire 18 with terminals. Here, each wire holding portion 14 is formed by bending a flexible metal plate, has a fixed end portion 14a and a clipping portion 14b, and an in-between portion therebetween is formed to be narrower in width than the fixed portion 14a and the clipping portion 14b. By inserting the aforementioned fixed end portion 14a into the corresponding aforementioned holding recess portion 12a so as to fit thereinto, the wire holding portion 14 is fixed to and held relative to the main portion 12 in a posture in which the clipping portion 14b projects further than the aforementioned one side surface 12f of the main portion 12. Furthermore, by similarly inserting the plurality of wire holding portions 14 into the respective holding recess portions 12a so as to fit thereinto, the plurality of wire holding portions 14 are supported in parallel in the longitudinal direction relative to the main portion 12.

Note that, here, although the plurality of wire holding portions 14 are supported so as to be arranged at equal intervals relative to the main portion 12, this need not necessarily be the case. For example, there may be a part where the wire holding portions 14 are arranged at relatively narrow intervals and a part where the wire holding portions 14 are arranged at relatively wide intervals.

The aforementioned clipping portion 14b has two end portions that face each other. Leading end side portions 14c of the two end portions slightly expand toward the leading end direction thereof base end side portions 14d of the two facing end portions slightly expand toward the base end direction thereof and in-between portions 14e therebetween serve as a narrowed portion and abut against each other.

Side plate portions 16 are fixed with screws or the like to both side surfaces adjacent to the one side surface 12f of the main portion 12 in which the aforementioned holding recess portions 12a are formed. These side plate portions 16 have a role of preventing the wire holding portions 14 inserted in and held by the aforementioned holding recess portions 12a from dislodging from the opening portions of these holding recess portions 12a.

With this wire holding bar 10, when an end portion of the wire 18 with terminals is inserted therein from the leading end side of the wire holding portion 14, the outer peripheral portion of this wire 18 with terminals comes into sliding contact with the inner surface of the leading end side portions 14c of the corresponding clipping portion 14b, and expands both end portions of this clipping portion 14b. Upon the wire 18 with terminals going beyond the in-between portions 14e that are the narrowed portion, both end portions of the clipping portion 14b are elastically restored to their original shape. Thereby, the end portion of the wire 18 with terminals is held in a locked manner between both end portions of the clipping portion 14b.

Returning to FIG. 2, the wire end portion holding and setting portion 32 here has a pair of wire end portion rotating portions 33 and a wire end portion conveying and setting portion 36.

The pair of wire end portion rotating portions 33 is configured to be able to rotate respective end portions of the wire 18 with terminals around the axes thereof as shown in FIGS. 1 and 2. The pair of wire end portion rotating portions 33 is provided at a position at which the respective end portions of the wire 18 with terminals can be received from the pair of wire end portion holding portions 27 at the aforementioned delivery position WP. If the end portions of the wire 18 with terminals are rotated, later conveyance, reception, delivery, and the like at the wire end portion conveying and setting portion 36 are performed such that the rotated posture is maintained as-is.

Note that whether or not to rotate the end portions of the wire 18 with terminals is determined in accordance with operations in downstream processes and is set in advance in a control unit 70, and the operation is performed in accordance with this setting. For example, if each end portion of the wire 18 with terminals is inserted into a connector housing in a downstream process, whether to rotate is determined in accordance with the insertion posture thereof. If no rotation is necessary, the wire end portion rotating portions 33 receive the end portions of the wire 18 with terminals from the wire end portion holding portions 27, and thereafter deliver the received end portions to the following wire end portion conveying and setting portion 36 without rotating them. Note that the wire end portion rotating portions 33 may also be omitted.

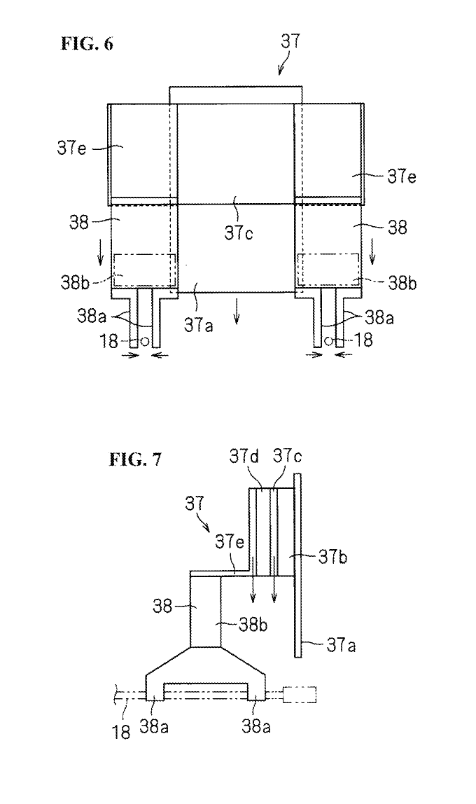

FIG. 5 is a front view showing the wire end portion conveying and setting portion 36, FIG. 6 is a front view showing a part of the wire end portion conveying and setting portion 36, and FIG. 7 is a side view showing a part of the wire end portion conveying and setting portion 36.

The wire end portion conveying and setting portion 36 is configured to sequentially set the end portions of the wire 18 with terminals received from the aforementioned wire end portion rotating portions 33 onto the wire holding bar 10. More specifically, the wire end portion conveying and setting portion 36 has a wire end portion holding and setting portion 37, and a setting portion moving mechanism portion 39 for moving the wire end portion holding and setting portion 37.

The wire end portion holding and setting portion 37 has a middle plate 37c supported such that the middle plate 37c can be driven to move up and down relative to a base plate 37a via a first up-and-down driving portion 37b, a pair of individual plates 37e supported such that the individual plates 37e can be driven to move up and down relative to the middle plate 37c via second up-and-down driving portions 37d, and a pair of holding portions 38 supported by the pair of individual plates 37e.

The aforementioned first up-and-down driving portion 37b is constituted by an actuator such as an air cylinder, and is configured to drive the middle plate 37c up and down. The two second up-and-down driving portions 37d are each constituted by an actuator such as an air cylinder, and are configured to separately drive the two individual plates 37e up and down. Thereby, the first up-and-down driving portion 37b is configured to synchronously drive the pair of holding portions 38 up and down, and the pair of second up-and-down driving portions 37d is configured to individually drive the pair of holding portions 38 up and down.

The two holding portions 38 are supported in a suspended manner by the respective individual plates 37e, and are configured to be able to hold and release the end portions of the wire 18 with terminals. More specifically, the holding portions 38 each has a pair of pawl portions 38a, and a pawl portion driving portion 38b that is constituted by an actuator such as an air cylinder and moves the two pawl portions 38a so as to approach and move away from each other. The two pawl portions 38a are each branched into two portions toward the leading end side, and are configured to be able to hold an end portion of the wire 18 with terminals at two positions at an interval in their longitudinal direction. The end portion of the wire 18 with terminals is held between both pawl portions 38a as a result of the two pawl portions 38a being moved so as to approach each other by the driving of the pawl portion driving portion 38b, and the end portion of the wire 18 with terminals between both pawl portions 38a is released as a result of the two pawl portions 38a being moved away from each other by the driving of the pawl portion driving portion 38b.

The setting portion moving mechanism portion 39 moves the aforementioned wire end portion holding and setting portion 37 back and forth between the position corresponding to the wire end portion rotating portions 33 and the bar support portion 50. Here, the setting portion moving mechanism portion 39 includes a pair of pulley bodies 39a, a motor 39b capable of driving one pulley body 39a to rotate in both forward and reverse directions, and an endless loop-shaped belt body 39c looped around the pair of pulley bodies 39a. The base plate 37a of the aforementioned wire end portion holding and setting portion 37 is coupled to a middle position in the aforementioned belt body 39c. By being rotationally driven in both forward and reverse directions by the motor 39b, the wire end portion holding and setting portion 37 is configured to be able to be driven back and forth between the position corresponding to the wire end portion rotating portions 33 and the bar support portion 50 and stop at any position in between. Note that the setting portion moving mechanism portion 39 can be constituted not only by the above configuration but also by various kinds of actuators such as a linear movement mechanism using a motor and a ball screw mechanism or the like.

This wire end portion conveying and setting portion 36 conveys the end portions of the wire 18 with terminals and sets these end portions onto the wire holding bar 10 as follows.

That is to say, the wire end portion holding and setting portion 37 is moved to an upper position corresponding to the wire end portion rotating portions 33 by the driving of the setting portion moving mechanism portion 39. Then, in a state where the two pawl portions 38a of each of the two holding portion 38 are separated from each other, the pair of holding portions 38 are lowered by the driving of the first up-and-down driving portion 37b, and the pair of pawl portions 38a of each of the two holding portions 38 are moved to a position at which the end portions of the wire 18 with terminals held by the wire end portion rotating portions 33 can be clipped (clamped). In this state, the two pawl portions 38a are moved so as to approach each other by the driving of the corresponding pawl portion driving portion 38b, and as a result, each end portion of the wire 18 with terminals is held by the corresponding pair of pawl portions 38a. Thereafter, the pair of holding portions 38 are lifted by the driving of the first up-and-down driving portion 37b, and furthermore, the wire end portion holding and setting portion 37 is moved upward of the wire holding bar 10 supported by the bar support portion 50 by the driving of the setting portion moving mechanism portion 39.

Above the wire holding bar 10 supported by the bar support portion 50, initially, the wire end portion holding and setting portion 37 is moved by the driving of the setting portion moving mechanism portion 39 such that the end portion of the wire 18 with terminals held by one of the holding portions 38 is located above the position in the corresponding wire holding portion 14 of the wire holding bar 10 at which the end portion is to be set. In this state, the one of the holding portions 38 is lowered to the position at which the end portion of the wire 18 with terminals held by the one of the holding portions 38 is held by the wire holding portion 14 to which the end portion is to be set, by the driving of the second up-and-down driving portion 37d or by the driving of both the first up-and-down driving portion 37b and the second up-and-down driving portion 37d. Then, the holding by the one of the holding portions 38 is canceled by moving the two pawl portions 38a of the one of the holding portion 38 away from each other by the driving of the pawl portion driving portion 38b. One of the end portions of the wire 18 with terminals is thereby set onto a desired wire holding portion 14.

The wire holding portion 14 of the wire holding bar 10 onto which each end portion of the wire 18 with terminal is to be set is determined in accordance with an operation command given to the control unit 70, as described later. That is to say, the order of manufacture of multiple types of wires 18 with terminals and the order of arrangement of the manufactured wires 18 with terminals are set through the operation commands, and the control unit 70 determines, based on the setting content, the wire holding portion 14 of the wire holding bar 10 onto which each end portion of the wire 18 with terminals that is being held is to be set. Then, the control unit 70 controls the wire end portion conveying and setting portion 36 for setting the end portion of the wire 18 with terminals onto the wire holding portion 14 at this position. Thereby, the end portions of multiple types of wires 18 with terminals are sequentially set onto respective wire holding portions 14 of the wire holding bar 10 so as to be arranged in the aforementioned set order.

Furthermore, by an operation command to manufacture the same type of wires 18 with terminals being input, the control unit 70 controls the wire end portion conveying and setting portion 36 so as to sequentially set the end portions of the same type of wires 18 with terminals onto respective wire holding portions 14 of the wire holding bars 10.

Note that the order of manufacture of multiple types of wires 18 with terminals and the order of arrangement the end portions of the wires 18 with terminals on the wire holding bar 10 may not necessarily coincide with each other. The order of manufacture and the order of terminal arrangement are determined as appropriate in accordance with manufacturing status in the next process, for example.

Therefore, the one of the holding portions 38 is lifted by the driving of the second up-and-down driving portion 37d or the driving of both the first up-and-down driving portion 37b and the second up-and-down driving portion 37d. Next, the end portion of the wire 18 with terminals held by the other holding portion 38 is set onto the other desired wire holding portion 14 by the same operations as those described above. After finishing setting both end portions of the wire 18 with terminals onto the respective wire holding portions 14 of the wire holding bar 10, the wire end portion holding and setting portion 37 is moved to an upper position corresponding to the wire end portion rotating portion 33 and the above operations are repeated by the driving of the setting portion moving mechanism portion 39. Both end portions of the wires 18 with terminals to which the terminals have been crimped by the cut-and-crimp mechanism portion 22 are thereby set onto the respective wire holding portions 14 of the wire holding bar 10 in the order of manufacture.

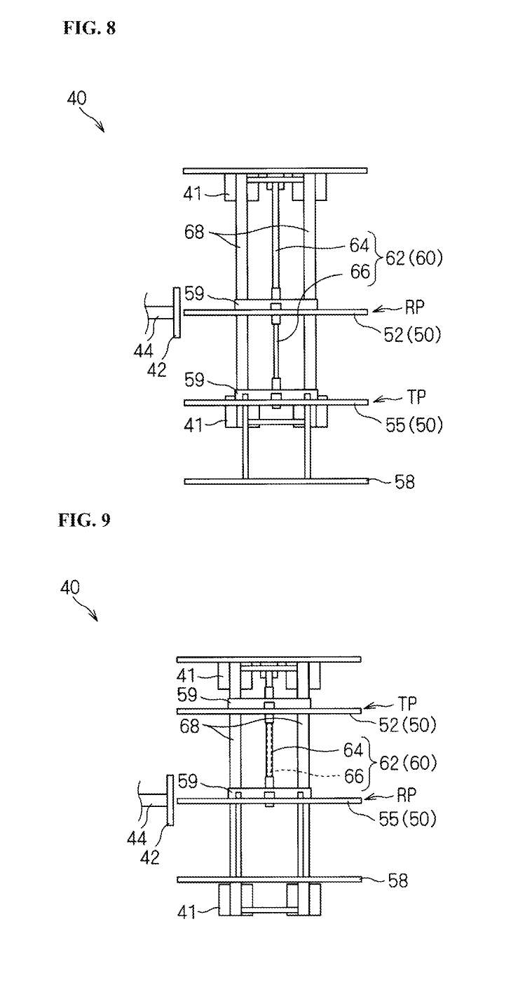

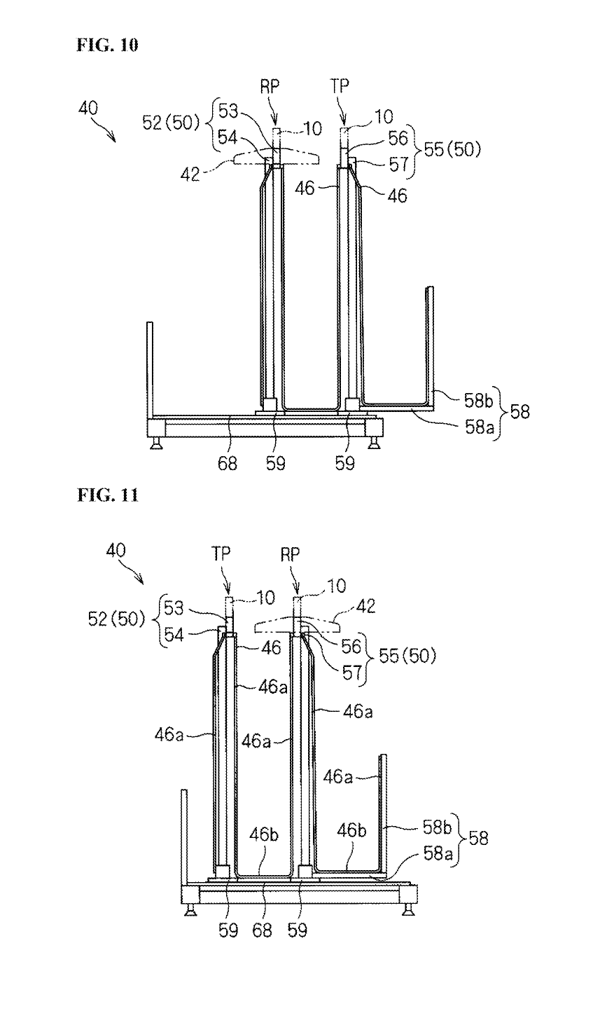

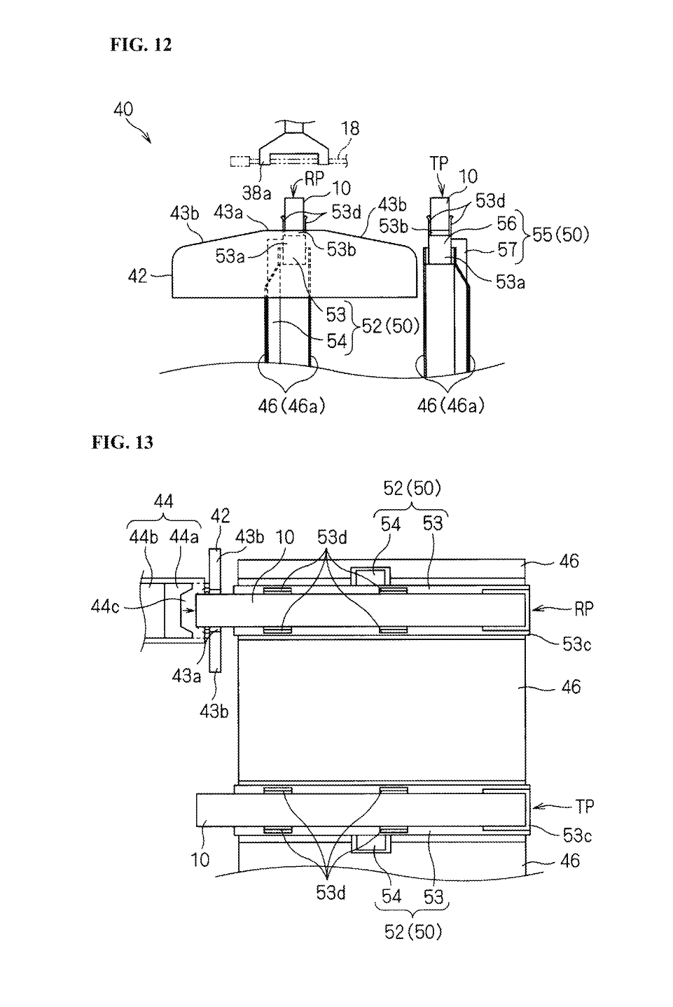

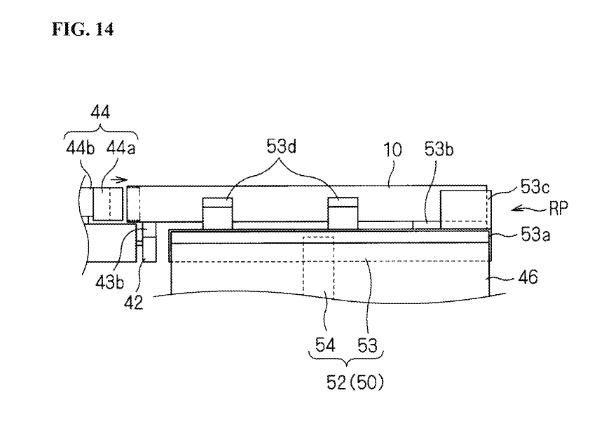

FIGS. 8 and 9 are schematic plan views showing the bar supply mechanism portion 40. FIGS. 10 and 11 are schematic side views showing the bar supply mechanism portion 40. FIGS. 8 and 10 show a state where a bar support portion 52, which is one of the two bar support portions 50, is located at its wire receiving position RP. FIGS. 9 and 11 show a state where a bar support portions 55, which is the other one of the two bar support portions 50, is located at its wire receiving position RP. FIGS. 12 to 14 are a side view, a plan view, and a front view, respectively, showing a part of the bar supply mechanism portion 40. Here, the bar supply mechanism portion 40 employs the following configuration such that processing is smoothly performed while replacing the wire holding bar 10 at which the end portions of the wire 18 with terminals are held with an empty wire holding bar 10.

That is to say, the bar supply mechanism portion 40 includes the two bar support portions 50 capable of supporting respective wire holding bars 10, and the moving mechanism portion 60 for moving the two bar support portions 50 back and forth between the wire receiving position RP at which a wire is received from the wire end portion holding and setting portion and the take-out positions TP at which the respective wire holding bars 10 are taken out. The take-out positions TP of the two bar support portions 50 are different with the wire receiving position RP therebetween in a direction perpendicular to the extending directions of the wire holding bars 10. Furthermore, here, the two bar support portions 50 are unitarily (integrally) moved with the same driving source such that the two bar support portions 50 can move back and forth in a state of having a fixed interval therebetween.

Specifically, here, the two bar support portions 50 are connected on their lower side in a state of being arranged in parallel (i.e., a state where the extending directions of the wire holding bars 10 supported by the two bar support portions 50 are parallel with each other). Then, the two bar support portions 50 can be unitarily moved back and forth by the moving mechanism portion 60 in a direction perpendicular to the directions in which the wire holding bars 10 extend. The take-out positions TP of the respective wire holding bars 10 supported by the two bar support portions 50 are thereby set on opposite sides relative to the wire receiving position RP. Note that, in the following description, one of the two bar support portions 50 will be called “the one bar support portion 52”, and the other will be called “the other bar support portion 55” as necessary.

The one bar support portion 52 has a bar support base 53 and a column portion 54. The bar support base 53 supports a part of the wire holding bar 10 on the side opposite to a part where the wire holding portions 14 are provided. The column portion 54 is a bar-shaped member extending in the vertical direction, and the bar support portion 52 is provided on one end thereof.

The bar support base 53 includes a beam portion 53a, a bar end portion support base 53b, a bar end portion support portion 53c, and bar clipping portions 53d.

The beam portion 53a is a bar-shaped member connected to the column portion 54. Here, the beam portion 53a is connected, at a middle position thereof to one end side of the column portion 54. The bar end portion support base 53b, the bar end portion support portion 53c, and the bar clipping portions 53d are provided in an upper part of the beam portion 53a.

The bar end portion support base 53b and the bar end portion support portion 53c are provided on one end side of the beam portion 53a, and are configured to be able to support one end side of the wire holding bar 10. Specifically, the plate-shaped bar end portion support base 53b is provided on an upper surface of the beam portion 53a on one end side, and the bar end portion support portion 53c is installed in an erected manner so as to surround the periphery of and a part above, one side end portion of the bar end portion support base 53b. That is to say, the bar end portion support portion 53c is formed in a rectangular shape as viewed in a plan view. Thereby, the wire holding bar 10 can be positioned in the extending direction thereof by pressing the wire holding bar 10 in the extending direction of the wire holding bar 10 toward the bar end portion support portion 53c.

Two bar clipping portions 53d are provided at an interval in the extending direction of the wire holding bar 10 so as to clip a middle position of the wire holding bar 10. The bar clipping portions 53d each include a pair of clipping pieces that are installed in an erected manner on the bar support base 53. The interval of the pair of clipping pieces is set so as to be wider on the leading end side than in a base portion thereof. The interval between the pair of clipping pieces in the base portion thereof is set to be about the same as the width dimension of the wire holding bar 10. Note that the number of bar clipping portions 53d to be provided may be one, or may be three or more. Alternatively, the bar clipping portions 53d may be omitted. If the bar clipping portions 53d are provided, the position of the wire holding bar 10 is not easily shifted in the width direction of the wire holding bar 10.

With the above-described configuration, the wire holding bar 10 is supported at one side end portion and at the middle position thereof by the bar support base 53. The other side end portion of the wire holding bar 10 is a free end. As a result of the bar support portion 52 thus supporting one end of the wire holding bar 10, when removing the wire holding bar 10 from the bar support portion 52, it can be removed just by shifting the wire holding bar 10 in the horizontal direction. For this reason, it is possible to facilitate the removal of the wire holding bar 10 and suppress an extra length part of the wire 18 with terminals getting entangled or caught at the time of the removal.

The other bar support portion 55 has a bar support base 56 and a column portion 57, which are similar to those described above, and the bar support base 56 is provided on one end side of the column portion 57. A coupling portion for connecting the column portion 54 of the one bar support portion 52 to the column portion 57 of the other bar support portion 55 at their other end side is provided. Furthermore, here, the column portion 54 of the one bar support portion 52 and the column portion 57 of the other bar support portion 55 are also connected to the moving mechanism portion 60.

Here, the bar supply mechanism portion 40 further includes a pair of floor contact portions 41. The moving mechanism portion 60 is configured to move the two bar support portions 50 back and forth in a partial zone between the pair of floor contact portions 41. The moving mechanism portion 60 is constituted by an actuator such as an air cylinder.

Specifically, here, the moving mechanism portion 60 is constituted by a cylinder tube 64, a piston 65 that moves within the cylinder tube 64, and an air cylinder 62 having a piston rod 66 connected to the piston 65. The cylinder tube 64 of the air cylinder 62 is provided in one of the floor contact portions 41. The one bar support portion 52 is located further on the air cylinder 62 side than the other bar support portion 55 is, and the piston rod 66 of the air cylinder 62 is connected to the other bar support portion 55. Thereby, the moving mechanism portion 60 directly moves the other bar support portion 55, and indirectly moves the one bar support portion 52 connected to the other bar support portion 55.

However, the piston rod 66 may be connected to other members that are continuous with the bar support portions 50, such as a later-described moving fence 58. In this case as well, the moving mechanism portion 60 can indirectly move the bar support portions 50. That is to say, the moving mechanism portion 60 need only be able to directly or indirectly move the bar support portions 50.

Note that, here, the axial direction of the air cylinder 62 is set to be perpendicular to the extending directions of the wire holding bars 10 supported by the bar support portions 50. The two bar support portions 50 can thereby move in a direction perpendicular to the extending directions of the wire holding bars 10.

However, it is not essential that the two bar support portions 50 can move in a direction perpendicular to the extending directions of the wire holding bars 10, and for example, the two bar support portions 50 may be able to move obliquely. That is to say, a configuration need only be employed in which the respective take-out positions TP of the two bar support portions 50 are located at different positions with the wire receiving position RP therebetween, and the two bar support portions 50 passing by each other can be suppressed.

Furthermore, here, the bar supply mechanism portion 40 further includes a pair of guide rails 68 extending in parallel between the pair of floor contact portions 41. The two guide rails 68 are provided one by one on both sides of the air cylinder 62 so as to sandwich the air cylinder 62. That is to say, the air cylinder 62 is provided so as to be located between the pair of guide rails 68. The two bar support portions 50 are configured to move on the guide rails 68.

Specifically, rail running portions 59, which have roughly the same length dimension as the width dimension between the pair of guide rails 68 and can move along the guide rails 68, are provided on the other end side of the column portions 54 and 57 of the bar support portions 50.

Thereby, it is possible to suppress the two bar support portions 50 dislodging from predetermined trajectories when the two bar support portions 50 are moved by the air cylinder 62 of the moving mechanism portion 60. Note that the guide rails 68 and the rail running portions 59 may be omitted.

When setting the end portions of the wire 18 with terminals onto the wire holding bar 10 supported by the one bar support portion 52, the one bar support portion 52 is moved to the wire receiving position RP by the driving of the moving mechanism portion 60 (the state in FIGS. 8 and 10). At this time, the other bar support portion 55 moves to the take-out position TP simultaneously with the movement of the one bar support portion 52. Thereby, an operator can remove the wire holding bar 10 on which the end portions of the wire 18 with terminals have been set from the other bar support portion 55, or set an empty wire holding bar 10 onto the other bar support portion 55.

After finishing setting the end portions of the wire 18 with terminals onto the wire holding bar 10 supported by the one bar support portion 52, the one bar support portion 52 is moved to the take-out position TP by the driving of the moving mechanism portion 60 (the state in FIGS. 9 and 11). At this time, the other bar support portion 55 moves to the wire receiving position RP simultaneously with the movement of the one bar support portion 52. Thereby, the wire holding bar 10 supported by the one bar support portion 52 can be detached while the end portions of the wire 18 with terminals are being set onto the wire holding bar 10 supported by the other bar support portion 55.

As described above, by alternately moving the two bar support portions 50 to the wire receiving position RP and the respective take-out positions TP, the setting of the end portions of the wire 18 with terminals onto the wire holding bar 10 and the detachment of the wire holding bar 10 can be continuously performed.

However, although an example in which one moving mechanism portion 60 unitarily moves the two bar support portions 50 has been described here, a configuration may be employed in which the bar supply mechanism portion 40 includes two moving mechanism portions 60, and one moving mechanism portion 60 moves one bar support portion 50. That is to say, the two bar support portions 50 may be configured to move individually. However, the configuration in which the two bar support portions 50 are unitarily moved by one moving mechanism portion 60 can simplify the equipment.

Furthermore, here, the bar supply mechanism portion 40 further includes a guiding portion 42. The guiding portion 42 is provided so as to be able to restrict the height of the other side end portion of the wire holding bar 10 supported by each bar support portion 50 in the extending direction when the bar support portion 50 move, such that the wire holding bar 10 supported by the bar support portion 50 is horizontal in a state of being located at the wire receiving position RP. That is to say, the guiding portion 42 is a part that restricts, at the wire receiving position RP, the other side end portion of the wire holding bar 10 at a predetermined height and set the wire holding bar 10 to be horizontal by supporting the other side end portion, which is a free end, of the wire holding bar 10.

Specifically, here, the guiding portion 42 is formed in an isosceles trapezoidal plate shape. The guiding portion 42 is provided so as to be at an interval from the bar support bases 53 and 56 in the extending direction of the wire holding bar 10 at the wire receiving position RP. The guiding portion 42 is provided such that the plate thickness direction thereof coincides with the extending directions of the wire holding bars. An upper surface of the guiding portion 42 has a support surface 43a and a guiding surface 43b extending from a support portion to both sides. The support surface 43a is provided parallel with a horizontal plane, and the height of the support surface 43a in the vertical direction is set so to be equal to the height of the upper surface of the bar end portion support base 53b. The guiding surface 43b extends in the moving direction of the bar support portions 50 such that the height thereof in the vertical direction gradually lowers from the support surface 43a.

At the take-out position TP, the other side end portion of the wire holding bar 10 is a free end, and the wire holding bar 10 is supported in a horizontal state or a state where the other side end portion is slightly lowered. If the wire holding bar 10 is supported in a state where the other side end portion is slightly lowered, the bottom surface thereof comes into contact with the guiding surface 43b of the guiding portion 42 and is guided to the support surface 43a when the wire holding bar 10 is moving from the take-out position TP toward the wire receiving position RP. Thereby, at the wire receiving position RP, the wire holding bar 10 is supported in a horizontal state by the support surface 43a of the guiding portion 42 and the upper surface of the bar end portion support base 53b. Therefore, the wire holding bar 10 is kept horizontal even while the wire is being set. Note that if the wire holding bar 10 is supported in a horizontal state at the take-out position TP, the other side end portion of the wire holding bar 10 is supported by the support surface 43a as-is without coming into contact with the guiding surface 43b.

Furthermore, here, the bar supply mechanism portion 40 includes a bar end portion support mechanism portion 44. The bar end portion support mechanism portion 44 is a part capable of pressing down the other side end portion of the wire holding bar 10 located at the wire receiving position RP toward the one side end portion.

Specifically, the bar end portion support mechanism portion 44 includes a bar end portion pressing portion 44a and a horizontal moving portion 44b. A recess portion 44c is formed in the bar end portion pressing portion 44a, and the bar end portion pressing portion 44a is configured such that a side surface of the other side end portion of the wire holding bar 10 is fitted into the recess portion 44c.

The horizontal moving portion 44b is constituted by an actuator such as the air cylinder 62, and is configured to be able to move the bar end portion pressing portion 44a back and forth in the horizontal direction. Here, the horizontal moving portion 44b is configured to be able to move the bar end portion pressing portion 44a in the extending direction of the wire holding bar 10.

In a state where an empty wire holding bar 10 has come to the wire receiving position RP, the bar end portion pressing portion 44a is moved in a direction of approaching the wire holding bar 10 by the horizontal moving portion 44b, and presses down the other side end portion of the wire holding bar 10 toward the one side end portion. Thereby, the wire holding bar 10 is set at a desired position in the extending direction thereof and an occurrence of a position shift can be suppressed during an operation of holding the wire.

After finishing setting a predetermined number of wires with terminals onto the wire holding bar 10, the bar end portion pressing portion 44a is moved in a direction of moving away from the wire holding bar 10 by the horizontal moving portion 44b. At this time, the bar end portion pressing portion 44a moves out of the area in which the wire holding bar 10 moves. Thereby, the wire holding bar 10 on which the setting of the wires has been completed can move toward the take-out position TP, and an empty wire holding bar 10 can move toward the wire receiving position RP. Subsequently, the above operations are repeatedly performed with the movement of the bar support portions 50.

Note that if the bar support portion 50 can fix the corresponding wire holding bar 10 at a correct position by, for example, supporting both ends of the wire holding bar 10, either one of; or both, the guiding portion 42 and the bar end portion support mechanism portion 44 may be omitted.

Furthermore, here, the entangling prevention sheet portion 46 is provided in at least a part of an area located below the wire holding bar 10 supported by each bar support portion 50. Here, it is assumed that “below the wire holding bar 10” includes not only a part immediately below the wire holding bar 10 but also obliquely below the wire holding bar 10.

Specifically, here, when setting the wire 18 with terminals onto the wire holding bar 10 supported by the one bar support portion 52, an extra length part thereof is set so as to be located between the one bar support portion 52 and the other bar support portion 55, as shown in FIG. 12. Therefore, the entangling prevention sheet portion 46 is provided between the one bar support portion 52 and the other bar support portion 55. The entangling prevention sheet portion 46 is provided for preventing the extra length part of the wire held by each wire holding bar 10, when being suspended, from getting entangled or caught on other members, for example.

More specifically, the entangling prevention sheet portion 46 is formed in a rectangular sheet shape. One side edge portion of the entangling prevention sheet portion 46 is attached to a side surface of the one bar support base 53, and the other side edge portion is attached to a side surface of the other bar support base 56. Here, the entangling prevention sheet portion 46 is attached to the bar support portions 50 by being adhered thereto with an adhesive tape or the like. The dimension of the entangling prevention sheet portion 46 in the longitudinal direction is set to be larger than the dimension between the bar support portions 50, and a middle area of the entangling prevention sheet portion 46 is suspended between the one bar support portion 52 and the other bar support portion 55. Thereby, here, the entangling prevention sheet portion 46 includes vertical portions 46a, which are parts extending in the vertical direction, and horizontal portions 46b, which are parts extending in the horizontal direction.

The vertical portions 46a are parts extending respectively along the column portions 54 and 57, and are parts for suppressing the extra length parts of the wires 18 with terminals getting caught on the column portions 54 and 57 or the like, or the extra length parts of the wires 18 with terminals getting entangled with each other as a result of swinging, for example, when the bar support portions 50 move.

The horizontal portions 46b are parts for suppressing the extra length parts of the wires 18 with terminals coming into contact with the floor and being rubbed therewith, for example, when the extra length parts are longer than the column portions 54 and 57.

However, it is not essential that the entangling prevention sheet portion 46 includes the vertical portions 46a and the horizontal portions 46b.

For example, a configuration may be employed in which two sheets are prepared as the entangling prevention sheet portion 46, only one side edge portions of the sheets are attached to different bar support bases 583 and 56, and the other side edge portions of the two sheets are free ends, thereby omitting the horizontal portions 46b. However, as a result of the entangling sheet portion 46 being provided so as to connect the two bar support portions 50 and including the horizontal portions 46b, the extra length parts of the wires 18 with terminals can be retained on the entangling prevention sheet portion 46 even if the extra length parts are longer than the column portions 54 and 57. Therefore, it is possible to suppress the extra length parts of the wires 18 with terminals being rubbed with the floor or the like.

Furthermore, for example, the vertical portions 46a can be omitted by attaching, as the entangling prevention sheet portion 46, both side edge portions of one sheet having a dimension in the longitudinal direction that is roughly equal to the dimension between the bar support portions 50 to different bar support portions. In this case, the horizontal portions 46b also has a part of the function of the vertical portions 46a of suppressing the extra length parts of the wires 18 with terminals getting caught on the column portions 54 and 57 or the like. However, by suspending a middle area of the entangling prevention sheet portion 46, the extra length parts of the wires 18 with terminals can also be suspended to the horizontal portions 46b of the entangling prevention sheet portion 46. Therefore, as a result of a reduction in the amount of the extra length parts of the wires 18 with terminals remaining on the entangling prevention sheet portion 46, the extra length parts of the wires 18 with terminals do not easily get entangled with each other.

Furthermore, here, the bar supply mechanism portion 40 further includes the moving fence 58. The moving fence 58 is connected to at least one of the two bar support portions 50, and can unitarily move with the two bar support portions 50.

Specifically, the moving fence 58 includes a coupling portion 58a and a fence portion 58b. The coupling portion 58a is connected to the other bar support portion 55, and is provided on the side opposite to the side where the one bar support portion 52 is provided relative to the other bar support portion 55. The fence portion 58b is installed so as to be erected on the coupling portion 58a, and is provided so as to be arranged parallel with the two bar support portions 50.

Here, when setting the wire 18 with terminals onto the wire holding bar 10 supported by the other bar support portion 55, the extra length part of each wire 18 with terminals is set so as to be located between the other bar support portion 55 and the fence portion 58b. Therefore, the entangling prevention sheet portion 46 is also provided between the other bar support portion 55 and the fence portion 58.

Between the other bar support portion 55 and the fence portion 58b as well, similarly to the above, the entangling prevention sheet portion 46 is provided by one side edge portion of the rectangular sheet being attached to the bar support portions 50, and the other side edge portion being attached to the fence portion 58b.

Thereby, it is also possible to press the wires 18 with terminals getting caught, entangled, or rubbed, for example, between the other bar support portion 55 and the fence portion 58b.

However, the entangling prevention sheet portion 46 may be omitted. Note that, in this case, the column portions 54 and 57 and the fence portion 58b formed in wall shape can replace the entangling prevention sheet portion 46.

Note that the operations of the aforementioned cut-and-crimp mechanism portion 22 and wire discharge device 30 are controlled by the control unit 70, which is constituted by a general microcomputer that includes a CPU, a ROM, a RAM, and the like. An input portion 72, which is constituted by various keys and the like, is connected to the control unit 70, and an operation instruction is input thereto through this input portion 72.

The control unit 70 receives, through the input portion 72, a command related to the order of manufacture of multiple types of wires 18 with terminals in the cut-and-crimp mechanism portion 22, and performs control for selecting multiple types of wires or multiple types of terminals in accordance with the command, and manufacturing the wires 18 with terminals corresponding to the command. This control unit 70 is configured to be able to receive, through the input portion 72, a command related to the order of arrangement of the terminals of the manufactured wires 18 with terminals, and is configured to set the end portions of each wire 18 with terminals onto the corresponding wire holding portion 14 of the wire holding bar 10 in accordance with the command. Furthermore, the control unit 70 is configured to be able to receive, through the input portion 72, a command regarding which end portion of which of the wires 18 with terminals manufactured by the cut-and-crimp mechanism portion 22 to rotate, and controls each of the aforementioned wire end portion rotating portions 33 for causing it to perform a necessary rotating operation.

Furthermore, the control unit 70 receives, through the input portion 72, a command related to the moving mechanism portion of the bar supply mechanism portion 40. Upon the wire holding bar 10 supported by the one bar support portion 52 holding a predetermined number of wires 18 with terminals in accordance with the command, the control unit 70 performs control for replacing the wire holding bar 10 with an empty wire holding bar 10 supported by the other bar support portion 55. Furthermore, the control unit 70 receives, through the input portion 72, a command related to the bar end portion support mechanism portion 44, and causes the horizontal moving portion 44b to perform an operation of approaching or moving away from an end portion of the wire holding bar 10 located at the wire receiving position RP in accordance with the command.

### Operations

A description will be given of overall operations of the cut-and-crimp setting device 1 and the wire discharge device 30 that are configured as described above.

Initially, the wire 18 with terminals is sequentially manufactured by the cut-and-crimp mechanism portion 22 by cutting a predetermined wire into a predetermined length and crimping predetermined terminals thereto (see FIG. 1). Then, both end portions of the manufactured wire 18 with terminals are conveyed to the delivery position WP by the pair of wire end portion holding portions 27 of the wire end portion back-and-forth driving portion 28. Note that it is determined whether to continuously manufacture the same type of wires 18 with terminals or to manufacture multiple types of wires 18 with terminals in a predetermined order, in accordance with a command given in advance to the control unit 70 through the aforementioned input portion 72.

Both end portions of the wire 18 with terminals are delivered to the pair of wire end portion rotating portions 33 at the delivery position WP. The end portions of the wire 18 with terminals are rotated by the respective wire end portion rotating portions 33 as necessary (see FIGS. 1, 3, and 4).

Both end portions of the wire 18 with terminals held by the pair of wire end portion rotating portions 33 are held by the pairs of holding portions 38 of the wire end portion conveying and setting portion 36, and are moved to the upper side of the wire holding bar 10 that is set on the bar support portion 50. The pair of holding portions 38 then individually move downward in a state of having moved to appropriate positions in the longitudinal direction of the wire holding bar 10, and the end portions of the wire 18 with terminals are set onto the respective wire holding portions 14 at desired positions in the wire holding bar 10 (see FIGS. 1 and 5 to 7).

By repeating the above processes on the wires 18 with terminals that are sequentially manufactured by the cut-and-crimp mechanism portion 22, both end portions of a plurality of wires 18 with terminals are set onto the respective wire holding portions 14 of the wire holding bar 10. Thereby, the wire holding bar 10 in which both end portions of the plurality of wires 18 with terminals are set onto the respective wire holding portions 14 is obtained.

Upon the setting of the wires 18 with terminals onto the wire holding bar 10 supported by the one bar support portion 52 being completed, the control unit 70 gives a command. An empty wire holding bar 10 supported by the other bar support portion 55 is moved to the wire receiving position RP and the set wire holding bar 10 supported by the one bar support portion 52 is moved to the take-out position TP in accordance with the command by the moving mechanism portion 60. Then, while the wires 18 with terminals are being set onto the wire holding bar 10 supported by the other bar support portion 55, the operator removes the set wire holding bar 10 supported by the one bar support portion 52, and attaches an empty wire holding bar 10 onto the one bar support portion 52 (see FIGS. 8 to 14).

By the operator thus repeating the operation of replacing the set wire holding bar 10 with an empty one at the take-out position TP, multiple sets of wire holding bars 10 on which the end portions of the wires 18 with terminals are set can be obtained.

### Effects

With the wire discharge device 30 configured as described above, the wire holding bar 10 in which the end portions of the wires 18 with terminals that have been cut out and to which terminals have been crimped are set in parallel onto the wire holding portions 14 can be obtained. Therefore, the convenience in operations in downstream processes can be improved, and damage, breakage, or the like of the wires and the terminals can be prevented.

Furthermore, the wire holding bar 10 in which the end portions of multiple types of wires 18 with terminals are arranged in a preset order in a plurality of wire holding portions 14 can be obtained. Therefore, for example, this order can be set as the order corresponding to the order of operations in the downstream processes, and the convenience in the operations in the downstream processes can be further improved.

In the case of manufacturing the same type of wires 18 with terminals as well, the wire holding bar 10 in which the end portions of the same type of wires 18 with terminals are arranged in parallel in a plurality of wire holding portions 14 can be obtained. Therefore, the convenience in the operations in the downstream processes can also be improved in the case of manufacturing the same type of wires 18 with terminals as well.

Since the end portions of each wire 18 with terminals are rotated by the wire end portion rotating portions 33, the end portions of the wire 18 with terminals can be set onto the wire holding portions 14 in a state of having rotated in a posture suitable for processing in the downstream processes. Therefore, more convenience in the operations of the downstream processes is achieved.

Furthermore, the take-out positions TP of the wire holding bars 10 supported by the two bar support portions 50 are different with the wire receiving position RP therebetween in a direction perpendicular to the extending directions of the wire holding bars 10. Therefore, the wire holding bars 10 do not easily pass by each other when moving back and forth between the wire receiving position RP and the respective take-out positions TP, and the wires getting entangled or caught can thereby be suppressed.

Furthermore, since the two bar support portions 50 are moved with the same driving source, the two bar support portions 50 can move back and forth in a state of always having a fixed interval therebetween. Therefore, the two bar support portions 50 do not pass by each other, and it is possible to suppress the wires getting entangled or caught Furthermore, the equipment structure can be more simplified than in the case of moving the two bar support portions with different driving sources.

The entangling prevention sheet portion 46 is provided in a part located below the wire holding bars 10 in the bar support portions 50. Therefore, it is possible to suppress the wires held at the wire holding bars 10 getting entangled or caught below the wire holding bars 10.

Each bar support portion 50 supports the one side end portion of the wire holding bar 10 in the extending direction, and further includes the guiding portion 42 capable of restricting the height of the other side end portion of the wire holding bar 10 supported by the bar support portion 50 in the extending direction when the bar support portion 50 moves. Therefore, the wire holding bar 10 supported by the bar support portion 50 is restricted so as to be horizontal in a state of being located at the wire receiving position RP. It is thereby possible to suppress an operation of setting a wire being started in a state where the wire holding bar 10 has not been set at a correct position. Furthermore, since the wire holding bar 10 is supported at one end, the wire holding bar 10 can be easily removed, and it is possible at the time of removal to suppress the wire getting entangled or caught.

The bar end portion support mechanism portion 44 capable of pressing down the other side end portion of the wire holding bar 10 in the extending direction toward the one side end portion in a state where the wire holding bar 10 supported by each bar support portion 50 is located at the wire receiving position RP is further provided. Therefore, it is possible to suppress the operation of setting a wire being started in a state where the wire holding bar 10 has not been set at the correct position.

Note that, although this embodiment has described an example in which both end portions of the wire 18 with terminals are set onto the wire holding bar 10, a configuration in which only one end portion of the wire 18 with terminals is set onto the wire holding bar 10 may also be employed. In this case, the other end portion of the wire 18 with terminals may be inserted in a connector housing, or may be in a bundled state. Terminals do not need to be crimped to both end portions of the wire 18 with terminals conveyed from the cut-and-crimp mechanism portion 22, and for example, a wire to which a terminal is crimped to only one end thereof may exist.

A mechanism portion for holding an end portion of the wire 18 with terminals immediately after the cut-and-crimp mechanism portion 22 has crimped terminals thereto may be provided as a configuration on the wire discharge device 30 side.

Although this invention has been described in detail as above, the above description is an example in all aspects, and this invention is not limited thereto. It would be understood that a number of modifications that have not been described as examples can be assumed without departing from the scope of this invention.

### LIST OF REFERENCE NUMERALS

10 Wire holding bar
14 Wire holding portion
18 Wire with terminals
22 Cut-and-crimp mechanism portion
30 Wire discharge device
32 Wire end portion holding and setting portion
33 Wire end portion rotating portion
36 Wire end portion conveying and setting portion
40 Bar supply mechanism portion
42 Guiding portion
44 Bar end portion support mechanism portion
46 Entangling prevention sheet portion
50, 52, 55 Bar support portion
60 Moving mechanism portion
70 Control unit
RP Wire receiving position
TP Take-out position

1. A wire discharge device comprising:
two bar support portions each configured to support a wire holding bar in which a plurality of wire holding portions are arranged in parallel;
a wire end portion holding and setting mechanism configured to sequentially set wires onto the plurality of wire holding portions of the wire holding bars supported by the bar support portions; and
a moving mechanism configured to move the two bar support portions back and forth between a wire receiving position at which a wire is received from the wire end portion holding and setting mechanism and a take-out position at which the wire holding bar is taken out,
wherein the take-out positions of the two bar support portions are spaced apart with the wire receiving position therebetween in a direction perpendicular to the direction in which the wire holding bars extend.

2. The wire discharge device according to claim 1,
wherein the moving mechanism unitarily moves the two bar support portions with the same driving source such that the two bar support portions can move back and forth while having a fixed interval therebetween.

3. The wire discharge device according to claim 1,
wherein an entangling prevention sheet is located below the wire holding bars supported by the bar support portions.

4. The wire discharge device according to claim 1,
wherein the bar support portions each support one side end portion of the wire holding bar in the extending direction, and
the wire discharge device further comprises a guiding portion capable of restricting a height of another side end portion of the wire holding bar supported by each of the bar support portions in the extending direction when the bar support portion moves, such that the wire holding bar supported by the bar support portion is horizontal while located at the wire receiving position.

5. The wire discharge device according to claim 4, further comprising:
a bar end portion support mechanism portion configured to press down the other side end portion of the wire holding bar in the extending direction toward the one side end portion in a condition in which the wire holding bar supported by each of the bar support portions is located at the wire receiving position.
